(19) United States
(12) Patent Application Publication
(10) Pub. No.: US 2009/0178863 A1
(43) Pub. Date: Jul. 16, 2009

(54) Tracked Vehicles

(75) Inventor: Kenneth Andrew Pink, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/189,316

(22) Filed: Aug. 11, 2008

(30) Foreign Application Priority Data
Jan. 11, 2008 (GB) 0800408.7

(51) Int. Cl. B62D 55/00

(52) U.S. Cl. 180/9.1; 901/1

(57) ABSTRACT

A track laying vehicle such as an EOD robot has an endless track on each side driven by a respective sprocket, and the vehicle is supported by a series of road wheels running on the tracks along each side. Each track comprises a series of tangs extending oppositely to the ground-engaging surfaces of the track and the road wheels are in parallel pairs to define circumferential grooves through which the tangs pass when the tracks are driven. The dimensioning of the tangs and grooves is such that the tangs are positively nipped by the road wheels during their passage to prevent the track from dropping out if not in contact with the ground—for example when the vehicle crosses a ditch or climbs over an obstacle—and resists shedding of the track in such circumstances.

The present invention relates to track laying vehicles. This form of traction is common for certain types of military and construction vehicles and requires that directional control is achieved by skid-steering, where the track on one side of the vehicle is caused to run at a different speed to the track on the other side of the vehicle to cause the vehicle to turn.

The invention has particular, though not exclusive, application to relatively small sized vehicles of this kind (say with a body length in the order of a metre), also known as robots, which may be used in hazardous or hostile environments for explosive ordnance disposal (EOD), inspection, reconnaissance, communications, rescue or other such tasks under autonomous control or under the control of a human operator located at a safe distance. Typically such robots comprise a self-propelled tracked platform carrying the various items of equipment suited to the task which it is intended to perform—such as manipulators, lights, antennas, cameras, microphones or other sensory devices—and a wireless link or control cable spool to pass commands and data from/to the remote operator. Robots of this kind have to be capable of operating over uneven terrain and manoeuvring within confined spaces, and operating in this respect with the utmost reliability. Tracked vehicles are generally preferred to wheeled vehicles for such tasks due to the greater mobility which they can provide including, in appropriate cases, turning on the spot.

A problem which can arise in the course of operating known vehicles of this kind, however, is shedding of a track, thereby rendering the vehicle immobile. If occurring during the course of an EOD mission, for example, this can cause the mission to be aborted or at best require a second vehicle to be deployed, possibly needing to move the first vehicle before the mission can be continued, and is in any event an outcome to be avoided if at all possible. In this respect the tracks of such vehicles are generally in the form of unitary moulded bands or are composed of a plurality of articulated links (also known as shoes), and are driven by a respective powered sprocket at one or both ends of the vehicle. The body of the vehicle is supported on each side by a series of rollers—known as road wheels—which run on the respective lengths of the tracks which are laid on the ground at any time. At least in the case of articulated tracks, each track link is typically formed with a tang (projection) on its face opposite to its ground-engaging face and the sprockets and road wheels are formed with circumferential grooves—or are disposed in parallel pairs to effectively define such a groove between them—through which the track tangs pass to maintain the correct alignment of the tracks on the vehicle. While this method of track alignment is normally effective so long as the vehicle operates over reasonably even surfaces, if a gap is present under part of one of the tracks—for example when the vehicle crosses a ditch or climbs over an obstacle—the unsupported track can sag under its own weight and corresponding track tangs can escape from the constraints of the road wheel grooves. If one or more tangs then reengage on the “wrong” side of a road wheel—which can occur particularly if the vehicle is also turning because very high lateral loads can be imparted to the tracks by skid steering—the track may become jammed or the following tangs will also tend to become disengaged as the track continues to be driven and the track will be shed.

The present invention seeks to avoid the above-described problem and in one aspect resides in a track laying vehicle comprising an endless driven track on each side of the vehicle and a plurality of road wheels along each side of the vehicle arranged to run on respective said tracks; each track comprising a series of tangs extending oppositely to the ground-engaging surfaces of the track and said road wheels comprising or being arranged to define circumferential grooves through which the tangs of the respective track are arranged to pass when the tracks are driven; and wherein in operation the road wheels are arranged to nip the tangs in the course of their passage through said grooves.

Nipping the tangs with the road wheels in accordance with the invention can act to resist the tangs dropping out of their grooves if a corresponding portion of track is unsupported from below and hence can obviate the risk of a track being shed in such circumstances.

In a preferred embodiment said road wheels are fitted with elastomeric tyres where they are adapted to nip said tangs.

Preferably also the lateral faces of said tangs and the confronting surfaces of said road wheels are both tapered.

The tracks of the vehicle may comprise respective series of articulated links and each said link preferably comprises a said tang located adjacent to the point of articulation of the link.

Preferably also the road wheels are comprised within bogies which are arranged to define a respective pair of said circumferential grooves in series, the spacing of said tangs along the respective track being so related to the spacing of each said pair of grooves that, within each said bogie, there is at least one tang at or close to the position of fullest engagement with at least one said groove at substantially all times.

The invention will now be more particularly described, by way of example, with reference to the accompanying drawings, in which:

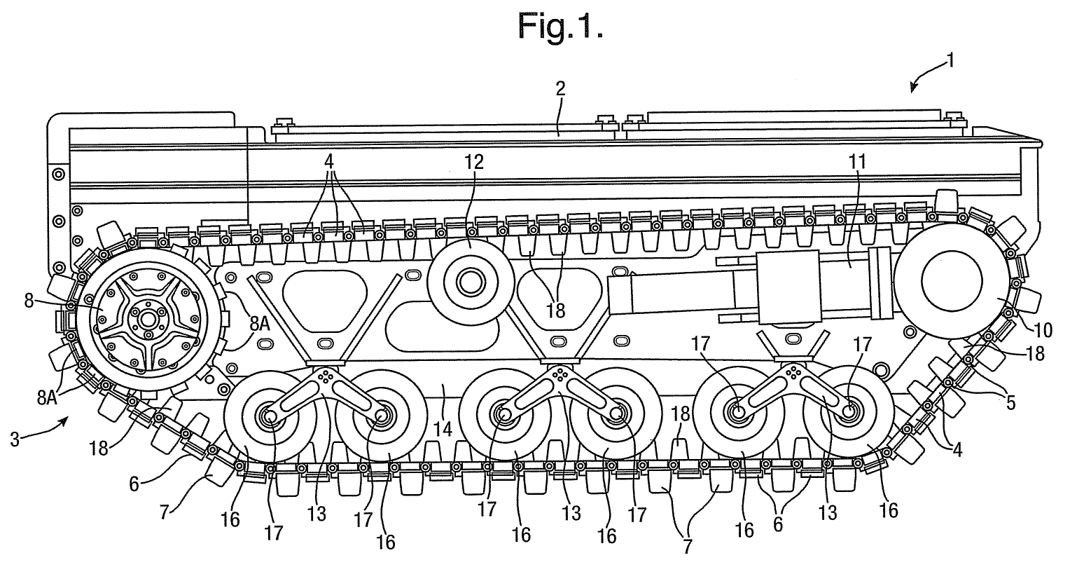

FIG. 1 is a side view of a preferred embodiment of a track laying vehicle according the to the invention;

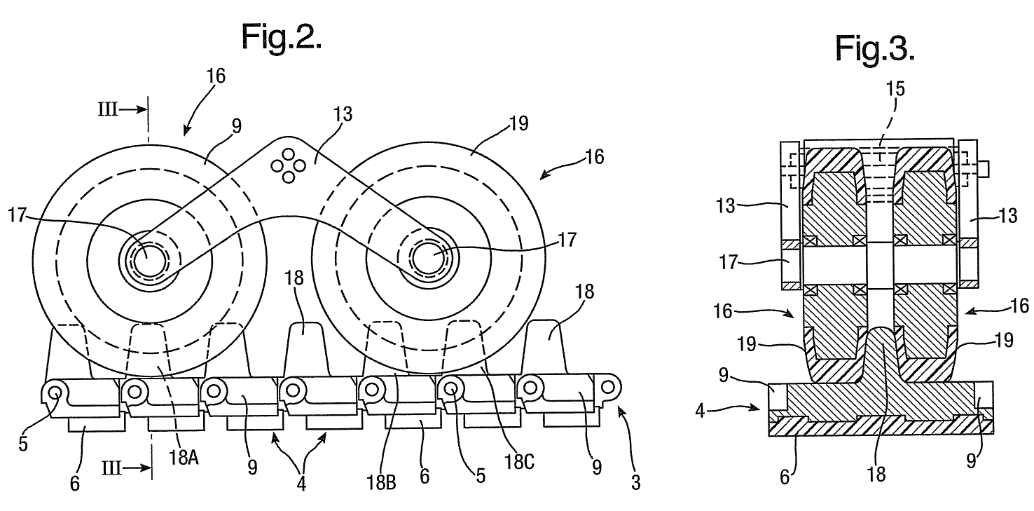

FIG. 2 is a side view, to an enlarged scale, showing the relationship between the track tangs and a road wheel bogie of the vehicle of FIG. 1, from which the nearer road wheels and swing arm have been omitted for clarity; and

FIG. 3 is a section on the line III-III of FIG. 2.

Referring to FIG. 1 there is shown one side of a vehicle 1, which can form the basis of an EOD robot, having an upper platform 2 for the mounting of a manipulator arm and such other pieces of equipment as may be suited to the tasks which it is to perform. For traction the vehicle is equipped with a pair of tracks 3, one at each side, and only one of which is seen in FIG. 1, it being understood that the illustrated track driving and road wheel arrangement will be duplicated in mirror image for the track on the opposite side of the vehicle to the one illustrated.

As seen also in FIG. 2, the track 3 is composed of a series of links 4, each articulated to the next by a respective pivot pin 5. To minimise the weight of the track each link is preferably injection moulded in a suitable engineering grade plastic such as Delrin®. The track links 4 are fitted with interchangeable ground-engaging track pads, e.g. of rubber, of which two different types are shown in FIG. 1, one 6 a low profile pad suited to operation on hard and smooth surfaces and the other 7 a deeper pad useful for operation over softer or more rugged terrain (it being understood that when the pads 7 are used they will be present at the illustrated spacing around the whole length of the track).

At the nominal rear end of the vehicle 1 a track drive sprocket 8 is provided, driven by an onboard electric motor, and equipped with two parallel circumferential series of teeth 8A which engage in recesses 9 in the opposite flanks of the track links (see also FIG. 3) to drive the track 3. At the opposite end of the vehicle there is an idler wheel 10 over which the track 3 passes and against which a track tensioning spring assembly 11 acts. A guide wheel for the upper run of the track is also provided at 12.

The body of the vehicle is supported at each side on the lower run of the respective track 3 by a series of three road wheel bogies, each such bogie comprising a pair of bifurcated swing arms 13 pivoted at their apices to the under chassis 14 of the vehicle on an associated rubber torsion block 15 (FIG. 3) and bearing two pairs of parallel road wheels 16 on shafts 17. The parallel arrangement of each road wheel pair is seen in FIG. 3.

Opposite to its track pad 6/7 each track link is formed with a tang 18. These tangs 18 pass through circumferential grooves (not shown) in the drive sprocket 8, idler wheel 10 and guide wheel 12, and through similar grooves effectively defined by the spacing between each parallel pair of road wheels 16, in order to maintain the correct alignment of each track 3 with respect to the vehicle. The tangs 18 are located close to the pivot points of the respective track links 4 and are tapered at their leading and trailing surfaces (as seen in FIGS. 1 and 2), in each case to maximise the available height of the tangs without adjacent tangs fouling each other as they pass around the sprocket 8, wheel 19 and foremost and rearmost road wheels 16. The lateral surfaces of the tangs 18 are also tapered, as seen in FIG. 3.

With further reference to FIGS. 2 and 3 each road wheel 16 is fitted with a solid rubber or polyurethene tyre 19 of a radial depth corresponding to at least a large proportion of the height of the tangs 18 and with tapered sides, although the taper angle of these tyres need not necessarily be the same as the lateral taper angle of the tangs. Furthermore, the lateral spacing between each pair of uncompressed road wheel tyres 19 is somewhat less than the lateral width of the tangs 18. It follows that as each tang 18 passes between a pair of road wheels 16, it is progressively nipped (pinched) by the confronting faces of the tyres 19 in a wiping action, the latter having sufficient compliance for substantially full face contact with the tang as it reaches the position of maximum penetration into the groove defined between the road wheels (i.e. the position of the tang 18A in FIG. 2). This nipping effect holds the tang 18 between the wheels 16 and prevents the adjacent part of the track 3 from dropping down out of the groove, with the attendant risk of shedding the track, even if that part of the track is not supported by contact with the ground at that time. Furthermore, the relative spacing of the tangs 18 along the track and between the two pairs of road wheels 16 in each bogie is such as to ensure that one tang is or is almost fully engaged between the tyres 19 of one pair in each bogie at substantially all times. That is to say if it is assumed that the road wheels 16 are travelling to the right relative to the track 3 in FIG. 2 then the tang 18A is fully engaged while the tang 18B has just passed the position of fullest engagement and the tang 18C is just about to reach the position of fullest engagement, and so on.

Various modifications may be made to the illustrated vehicle without departing from the scope of the invention, of which the following are specific examples.

Instead of disposing the road wheels 16 in serial pairs in bogies, the vehicle may be fitted with a series of individual leading or trailing swing arm assemblies along each side, each with a single set of parallel road wheels. These will have the same track retaining capability by nipping the tangs 18 e.g. as indicated in FIG. 3. Also it will preferably be arranged that within each succeeding pair of road wheel sets there is a tang fully engaged or almost fully engaged at substantially all times, as described above for the bogie arrangement.

Although the invention has been described in terms of tracks with a single tang 18 on each link 4, for larger vehicles it may be preferable to have two tangs in parallel on each link. The road wheels will then be in threes rather than pairs, so as to collectively define two parallel grooves corresponding to the two tangs.

Instead of the sprockets 8 driving the respective tracks by engaging the track link flanks as described above, they could be configured to drive by engagement with the tangs 18.

1. A track laying vehicle comprising an endless driven track on each side of the vehicle and a plurality of road wheels along each side of the vehicle arranged to run on respective said tracks; each track comprising a series of tangs extending oppositely to the ground-engaging surfaces of the track and said road wheels comprising or being arranged to define circumferential grooves through which the tangs of the respective track are arranged to pass when the tracks are driven; and wherein in operation the road wheels are arranged to nip the tangs in the course of their passage through said grooves so as to prevent the tangs dropping out of the grooves if a corresponding portion of track is unsupported from below.

2. A vehicle according to claim 1 wherein said road wheels are fitted with elastomeric tyres where they are adapted to nip said tangs.

3. A vehicle according to claim 1 wherein the lateral faces of said tangs and the confronting surfaces of said road wheels are both tapered.

4. A vehicle according to claim 1 wherein said tracks comprise respective series of articulated links and each said link comprises a said tang located adjacent to the point of articulation of the link.

5. A vehicle according to claim 1 wherein, for each successive pair of said circumferential grooves along each side of the vehicle it is arranged that there is at least one tang at or close to the position of fullest engagement with at least one said groove at substantially all times.

6. A vehicle according to claim 1 wherein said road wheels are comprised within bogies which are arranged to define a respective pair of said circumferential grooves in series.

7. A vehicle according to claim 6 wherein the spacing of said tangs along the respective track is so related to the spacing of each said pair of grooves that, within each said bogie, there is at least one tang at or close to the position of fullest engagement with at least one said groove at substantially all times.

8. A vehicle according to claim 1 being a robotic vehicle.
